(19) United States
(12) Patent Application Publication
(10) Pub. No.: US 2022/0170620 A1
(43) Pub. Date: Jun. 2, 2022

(54) ILLUMINATION DEVICE FOR STORAGE UNITS

(71) Applicant: Steve Harvey, Austin, TX (US)

(72) Inventor: Steve Harvey, Austin, TX (US)

(21) Appl. No.: 17/538,117

(22) Filed: Nov. 30, 2021

Related U.S. Application Data
(60) Provisional application No. 63/205,281, filed on Nov. 30, 2020.

(51) Int. Cl. F21V 23/04; F21V 33/00

(52) U.S. Cl. CPC F21V 23/04; F21Y 2115/10; F21V 33/006

(57) ABSTRACT

An illumination device for a storage unit having a locking system attached to a storage door and a containment space with an interior includes a housing attached to the storage door and at least one light source electrically communicated with an actuator is disclosed. The housing includes a link mechanism operatively connected to the locking system of the storage door and the actuator operatively connected to the link mechanism. Further, the actuator is operable to activate the locking system of the storage door between an unlocked state and a locked state, and is activated to turn the light source to an ON state when the link mechanism connected to the locking system is moved to the unlocked state from the locked state such that the light source radiates the light towards the containment space of the storage unit.

### CROSS-REFERENCE TO RELATED APPLICATION

This application claims the benefit of U.S. Provisional Application No. 63/205,281, filed Nov. 30, 2020, the content of which is incorporated herein by reference in its entirety.

### FIELD

The present disclosure relates to storage units, and more particularly to illumination of a containment space and/or surroundings of the storage units.

### BACKGROUND

The statements in this section merely provide background information related to the present disclosure and may not constitute prior art.

Storage units (e.g., compartments) in vehicles are often used in places with lighting that causes a containment space to be darkened or difficult to see. In order to improve visibility, an external light source, such as a light mounted to a top surface of the storage unit or a flashlight held by a user, is typically used to shine down into the containment space. However, this solution is cumbersome and unwieldy, as the light obstructs access to the storage unit and the flashlight ties up the user's hands, which makes the task of filling or removing objects from the storage unit more difficult. Further, the entire interior of the containment space is not properly illuminated, either by limitations of the light or shadows created by the presence of large objects, which cast a shadow that occludes the far reaches of the inside of the storage unit.

Depending on the application, the light is generally mounted inside the storage unit in various positions and directions, usually depending on where there is still space for the storage unit, considering the design of the interior space of the storage unit, depending on the preferred angle from which the storage unit light is to illuminate the inside of the storage unit. However, these factors vary from application to application so that a light with a standard radiation profile can often only achieve an unsatisfactory compromise with regard to achievable storage unit lighting. Further, it can even be the case that the light has to be positioned so unfavorably due to the lack of space inside the storage unit that the light produces a glare effect which hinders a user standing in front of the opened storage door. For example, the light can be pointed at the storage door so that at least some of the light issuing from the illuminating means also radiates in the direction of the storage unit door, thereby possibly blinding a user standing in front of the storage unit.

### SUMMARY

The present disclosure generally relates to illumination of storage units. In particular, the present disclosure relates to compartments (storage units) in a vehicle such as emergency vehicles including fire trucks and ambulances, motor homes, camping trailers including recreation vehicles (RVs), and utility trucks with compartments and in a tool box unit, a storage cabinet, and any storage compartment built in a structure. The illumination device in the present disclosure can be used alone, and further when the illumination device is used with a power lock feature installed in the storage door, the light and location of the illumination device is unique and ideal because the location of the lock feature built on the storage door casts light into interior spaces of the compartments and also exterior areas around the compartments. Accordingly, the illumination device of the present disclosure can be effective for a user to work in front of the storage unit with the opened storage door.

According to one aspect of the present disclosure, an illumination device for a storage unit having a locking system attached to a storage door and a containment space with an interior includes a housing attached to the storage door and at least one light source electrically communicated with an actuator. The housing includes a link mechanism operatively connected to the locking system of the storage door and the actuator operatively connected to the link mechanism. Further, the actuator is operable to activate the locking system of the storage door between an unlocked state and a locked state, and is activated to turn the light source to an ON state when the link mechanism connected to the locking system is moved to the unlocked state and from the locked state such that the at least one light source radiates light towards the containment space.

According to a further aspect of the present disclosure, the actuator is activated to turn the light source to an OFF state when the link mechanism connected to the locking system is moved to the locked state from the unlocked state.

According to a further aspect of the present disclosure, the link mechanism includes a lock bolt operatively connected to a lock body of the locking system such that the link mechanism having the lock bolt is operable to activate the actuator to electrically communicate with the light source. The lock bolt is operatively coupled with a cylinder pin of the locking system such that the cylinder pin is moved in the lock bolt between the unlocked state of the locking system and the locked state of the locking system. The lock bolt is formed with a stepped slot having a first location and a second location to receive the cylinder pin such that when the cylinder pin is positioned in the first location, the locking system is in the locked state and when the cylinder pin is positioned in the second location, the locking system is in the unlocked state. In the unlocked state of the locking system, a user key stays in a key hole arranged in an outer side of the storage door.

According to a further aspect of the present disclosure, the link mechanism further includes a nose piece connected to the actuator and scissor arms connected to the nose piece such that the link mechanism of the illumination device is configured to allow the actuator to electrically communicate with the light source between the locked state and the unlocked state of the locking system.

According to a further aspect of the present disclosure, the light source is formed with a strip shape and attached to the housing along a longitudinal direction of the housing. The light source is formed with a V-shape and attached directly to an inner side of the storage door.

According to a further aspect of the present disclosure, the light source is a light emitting diode (LED) and radiates light in a direction to the interior of the containment space.

According to a further aspect of the present disclosure, the illumination device is generally applied to a cross bed storage unit, a service truck compartment, a recreation vehicle (RV) compartment, and a tool box unit.

According to another aspect of the present disclosure, the lock bolt is formed with a cam type and the cam type includes a slot having a first end and a second end to receive the cylinder pin such that the locking system is in the locked state when the cylinder pin is positioned in the first end and the locking system is in the unlocked state when the cylinder pin is positioned in the second end.

According to a further aspect of the present disclosure, the link mechanism further includes a connecting bar between the actuator and the lock bolt such that the connecting bar of the illumination device is configured to allow the actuator to electrically communicate with the light source between the unlocked state and the locked state of the locking system.

Further details and benefits will become apparent from the following detailed description of the appended drawings. The drawings are provided herewith purely for illustrative purposes and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1A shows a side view of a vehicle having storage units, and FIG. 1B shows an interior of the storage unit with an illumination device in accordance with an exemplary form of the present disclosure;

FIG. 2A shows an outer side of a storage door in the storage unit of FIG. 1B, and FIG. 2B shows the illumination device attached to an inner side of the storage door of FIG. 1B;

FIG. 3 shows an exploded view of the illumination device of FIG. 2B;

FIG. 4A shows a perspective view of a lock bolt of the illumination device of FIG. 3, and FIG. 4B shows a plan view of the lock bolt of FIG. 4A;

FIG. 5A shows a plan view of the lock bolt coupled with a locking system in a locked state of the storage door of FIG. 2A, and FIG. 5B show a plan view of the lock bolt coupled with the locking system in an unlocked state of the storage door of FIG. 2A;

FIG. 6 shows a plan view of a light source used in an illumination device in accordance with another exemplary embodiment of the present disclosure;

FIG. 7 shows a plan view of an illumination device in accordance with another exemplary embodiment of the present disclosure; and

FIG. 8A shows a cross bed tool box built in a vehicle, FIG. 8B shows the cross bed tool box having an illumination device of the present disclosure, FIG. 8C shows compartments built in a service truck with the illumination device of the present disclosure, FIG. 8D shows a recreation vehicle (RV) having a storage unit, and FIG. 8E shows the interior of the storage unit with the illumination device of the present disclosure.

The drawings described herein are for illustration purposes only and are not intended to limit the scope of the present disclosure in any way.

### DETAILED DESCRIPTIONS

The following description is merely exemplary in nature and is in no way intended to limit the present disclosure or its application or uses. It should be understood that throughout the drawings, corresponding reference numerals indicate like or corresponding parts and features.

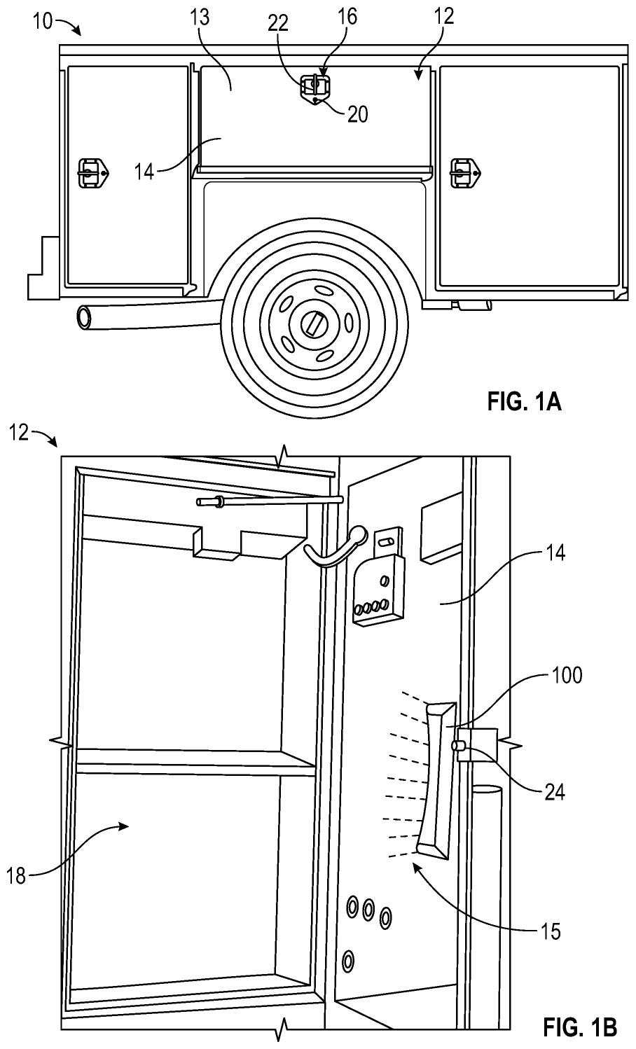

FIGS. 1A and 1B show a vehicle 10 having compartments such as storage units 12. For example, the vehicles 10 having the storage units 12 are ambulances, motor homes, camping trailers, utility trucks with compartments. In another approach, the storage units of the present disclosure can be tool boxes, storage cabinets, any storage compartments built in any structures, etc. In FIGS. 1A and 1B, each storage unit 12 generally includes a storage door 14 with a locking system 16, and also containment spaces 18 with an interior (see FIG. 1A). Further, as shown in FIGS. 1A and 1B, the locking system 16 includes a key hole 20 and a handle 22 arranged on an outer side 13 of the storage door 14 and a lock body 24 arranged on an inner side 15 of the storage door 14 such that the lock body 24 is operatively connected with the key hole 20 and the handle 22 through the storage door 14. As shown in FIGS. 1A and 1B, a user can access the inside of the containment space 18 by unlocking the locking system 16 arranged in the storage door 14 of each storage unit 12.

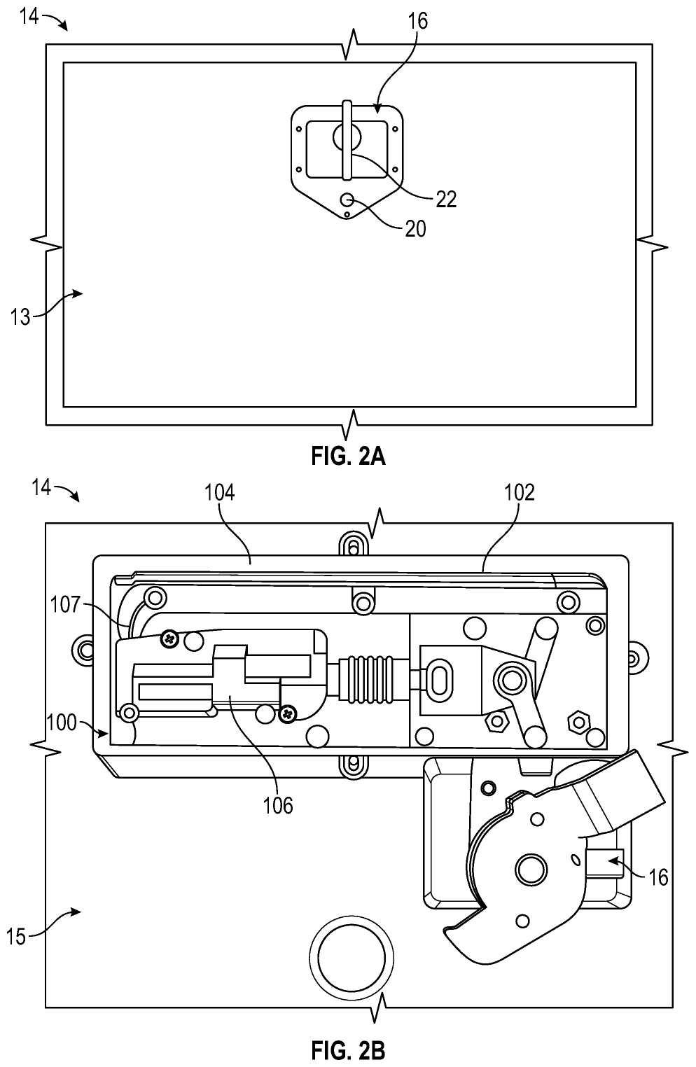

FIGS. 2A and 2B illustrate the storage door 14 having an illumination device 100 such as a light actuated cover (LAC) attached to the inner side 15 of the storage door 14 and adapted to radiate or direct light towards the inside of the storage unit 12. The illumination device 100 is operatively coupled with the locking system 16 arranged in the outer side 13 and the inner side 15 of the storage door 14 such that the illumination device 100 is adapted to radiate light into the containment space 18 of the storage unit 12 when such containment space 18 is opened to illuminate the contents of the containment space 18. Further, as shown in FIG. 1B, the illumination device 100 is adapted to radiate light in the exterior areas around the containment spaces 18 in addition to the interior of the containment space 18.

As shown in FIG. 2B, the illumination device 100 includes a housing 104 and at least one light source 102 attached to the housing 104 to radiate light in the interior of the containment space 18 of the storage unit 12. However, in another approach, one or more illumination devices 100 can be disposed to the storage unit 12 in the inner side 15 of the storage door 14 and in a structural feature of the storage unit 12. In accordance with an exemplary embodiment of FIG. 2B, the illumination device 100 is attached to the inner side 15 of the storage door 14, thereby enabling and facilitating modular installation and locating differently constructed storage units. Accordingly, the illumination device 100 can be installed as an Original Equipment Manufacturer (OEM) option or retro-fitted as an aftermarket add-on option.

As shown in FIG. 2B, the light source 102 is an array or single element of one or more of light emitting diodes (LEDs), incandescent, halogen, fluorescent bulbs, high intensity discharge (HID), mercury lamp bulbs, or the like, operatively connected to a power source (not shown). The intensity of the light and/or focus of the light radiating from the light source 102 is selectively directed and aimed using lenses or optical filters to illuminate a desired containment space, a section of the containment space, and/or surroundings of the storage unit 12. The array of the light source 102 includes any combinations of the light source types.

The light source 102 in FIG. 2B, whether arrays or individual bulbs or diodes, is referred to simply as the light source 102. As described above, the light source 102 attached to the housing 104 is generally attached to the inner side 15 of the storage door 14. In particular, the housing 104 including the light source 102 is arranged near the locking system 16 of the storage door 14 and operatively connected with the lock body 24 of the locking system 16. As shown in FIG. 2B, the illumination device 100 having the light source 102 is coupled with the locking system 16 and the light source 102 is adapted to generally radiate light according to the movement of the locking system 16. Further, when the housing 104 of the illumination device 100 is attached to the inner side 15 of the storage door 14, the light source 102 is oriented to direct light towards the interior of the containment space 18 (see FIG. 1B).

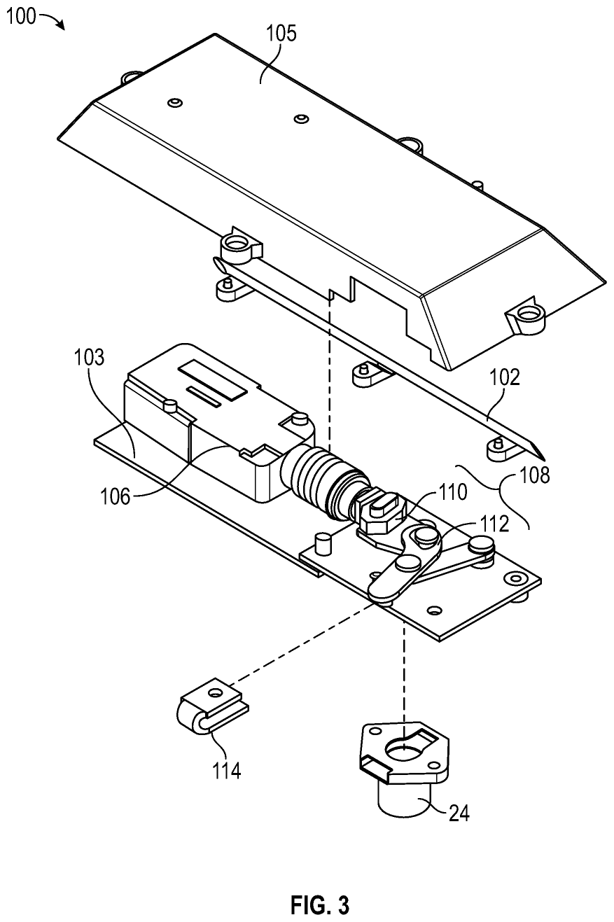

FIG. 3 illustrates an exploded view of the illumination device 100 with lock body 24 of the locking system 16. In FIG. 3, the illumination device 100 includes a base plate 103, an actuator 106, and a link mechanism 108. As shown in FIG. 2B, the housing 104 of the illumination device 100 is formed with the base plate 103 and the housing cover 105, and the housing 104 is attached to the inner side 15 of the storage door 14. Further, as shown in FIG. 3, the actuator 106 is attached to the base plate 103 and the link mechanism 108 is operatively coupled with the base plate 103. The link mechanism 108 of the illumination device 100 further includes a nose piece 110 connected to the actuator 106 and scissor arms 112 is operatively connected to the nose piece 110.

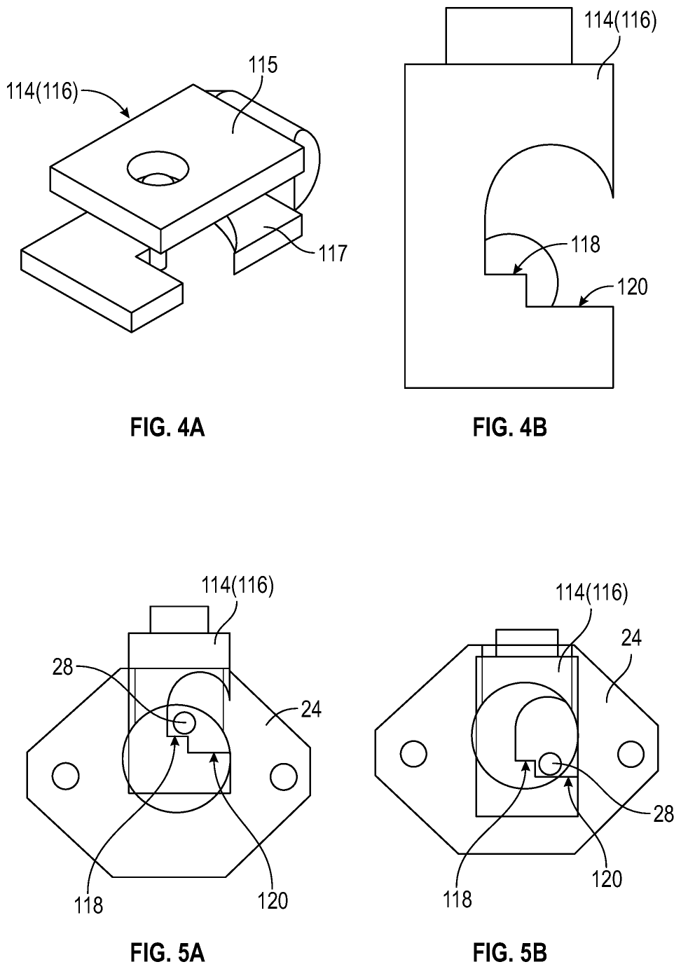

In addition, as shown in FIG. 3, the link mechanism 108 further includes a lock bolt 114 connected to the scissor arms 112. In accordance with an exemplary form of FIGS. 4A and 4B, the lock bolt 114 is formed with a C-type bracket 116 having a first side 115 and a second side 117. The first side 115 of the lock bolt 114 is connected with the scissor arms 112 of the link mechanism 108 and the second side 117 is operatively coupled with the lock body 24 of the locking system 16. Accordingly, the actuator 106 operatively connected to the link mechanism 108 is activated according to the operational states (a locked state or an unlocked state) of the locking system 16 in the storage door 14.

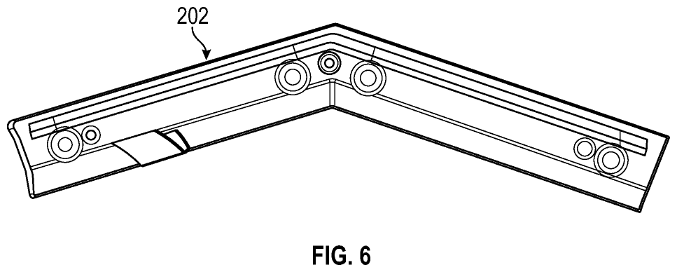

Referring back to FIG. 2A, the storage door 14 has the key hole 20 receiving a user key (not shown) to lock and unlock the storage door 14. The locking system 16 of the storage door 14 further includes a cylinder pin 28 moving between a locked position and an unlocked position by the user key (see also FIGS. 5A and 5B). The cylinder pin 28 is operatively coupled with the lock bolt 114 formed with a stepped shape having a first location 118 and a second location 120. In FIG. 5A, the cylinder pin 28 is positioned in the first location 118 of the lock bolt 114 when the locking system 16 of the storage door 14 is locked and in FIG. 5B, the cylinder pin 28 is positioned in the second location 120 of the lock bolt 114 when the locking system 16 of the storage door is unlocked. Accordingly, as shown in FIGS. 5A and 5B, when the cylinder pin 28 is moved to the second location 120 of the lock bolt 114 from the first location 118 of the lock bolt 114, the link mechanism 108 connected to the lock bolt 114 moves and triggers the actuator 106 connected to a power source (not shown) to allow the locking system 16 to completely unlock the storage door 14 by the power actuator 106 such that the user can open the storage door 14.

The power source is provided with electric battery(s), fuel cell(s), or any other power systems, which are pre-installed in the vehicle 10. Accordingly, electric wires 107 (see FIG. 2B) of the actuator 106 are connected to the power source for receiving electric energy. Further, as shown in FIG. 3, the light source 102 of the illumination device 100 is also electrically connected with the actuator 106 and also the power source such that the actuator 106 is provided and can be adapted to turn the light source 102 ON or OFF based on the storage door 14 being in an open (unlocked) or closed (locked) state. When the storage door 14 is opened (i.e., the locking system 16 of the storage door 14 moves in the unlocked state), the cylinder pin 28 is moved in the second location 120 of the lock bolt 114 and the actuator 106 connected to the link mechanism 108 is actuated to electrically connect the light source 102 to the power source to turn the light source 102 to the ON state, thus causing illumination. Conversely, when the storage door 14 is closed (i.e., the locking system 16 of the storage door 14 moves in the locked state), the cylinder pin 28 is moved in the first location 118 of the lock bolt 114 and the actuator 106 connected to the link mechanism 108 is actuated to electrically disconnect the light source 102 from the power source and turn the light source 102 to the OFF state. Further, when the light source 102 is the ON state, the light source 102 attached to the storage door 14 is oriented to emit or radiate light in a direction into the containment space 18 along with the opening position of the storage door 14.

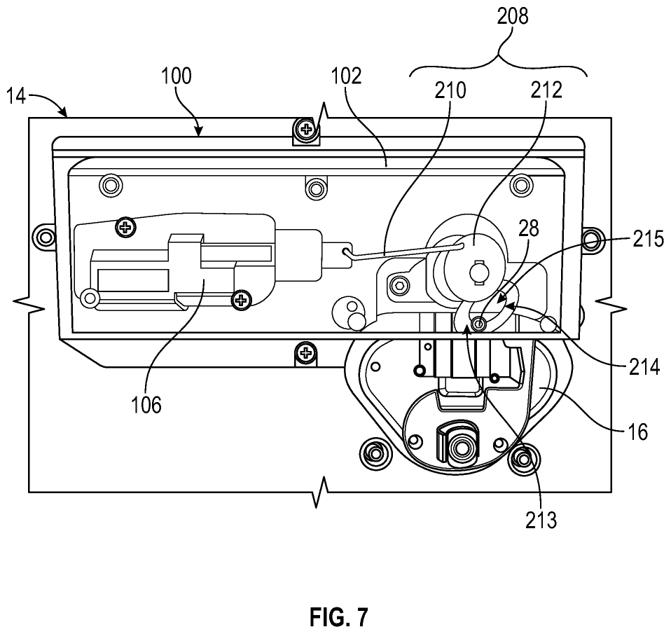

Referring back to FIGS. 2B and 3, as an example, one light source 102 formed with a strip shape is attached to the housing 104 in a longitudinal direction of the housing 104. However, in another approach, a light source 202 is formed with at least two strips and arranged in a V-shape in the housing 104. For example, as shown in FIG. 6, the light source 202 having the V-shape is directly attached to the inner side 15 of the storage door 14 and the wire of the light source 202 is connected with the actuator 106 and the power source such that the light source 202 is adapted to be controlled by the actuator 106. In another approach, the V-shaped light source 202 can be attached to the housing 104 (not shown) instead of the strip shape attached to the housing 104. Further, in accordance with another embodiment of the present disclosure, the light source 102 can be formed with various shapes for radiating light in a direction of the containment space 18 of the storage unit 12.

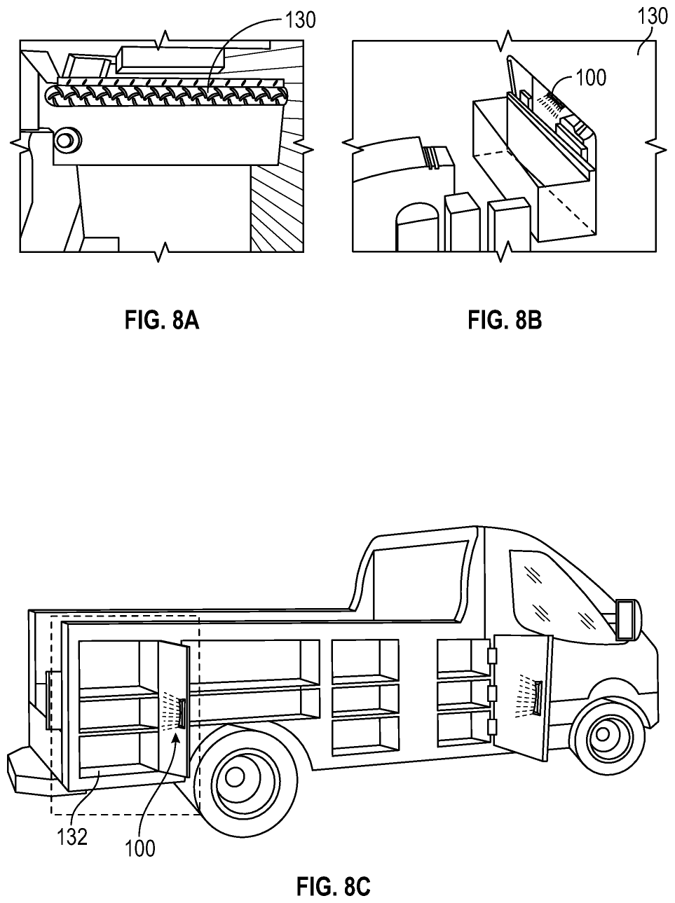

FIG. 7 illustrates another exemplary embodiment of the present disclosure. In FIG. 7, the housing 104 attached to the inner side 15 of the storage door 14 includes a new link mechanism 208 operatively connected to the actuator 106 and also the locking system 16 of the storage door 14. The link mechanism 208 includes a connecting bar 210 and a cam 212 rotationally coupled with the lock body 24 of the storage door 14. Further, as shown in FIG. 7, the cam 212 is formed with a slot 214 receiving the cylinder pin 28 of the locking system 16 and the cam 212 rotatably moves between the unlocked state and the locked state of the locking system 16. When the storage door 14 is closed and locked, the cylinder pin 28 is positioned in a first end 213 of the cam 212 and the actuator 106 connected to the link mechanism 208 is actuated to electrically disconnect the light source 102 from the power source and turn the light source 102 to an OFF state. Further, when the storage door 14 is unlocked, the cylinder pin 28 is positioned in a second end 215 of the cam 212 and the actuator 106 connected to the link mechanism 208 is actuated to electrically connect the light source 102 from the power source and turn light source 102 to an ON state. Accordingly, as shown in FIG. 7, the light source 202 electrically connected with the power source and also the actuator 106 radiates or directs light towards the containment space 18 of the storage unit 12 when the storage door 14 is unlocked and opened. In accordance with other exemplary embodiments of the present disclosure, the cam 212 can be generally formed with other shapes to move the locking system 16 between the unlocked state and the locked state.

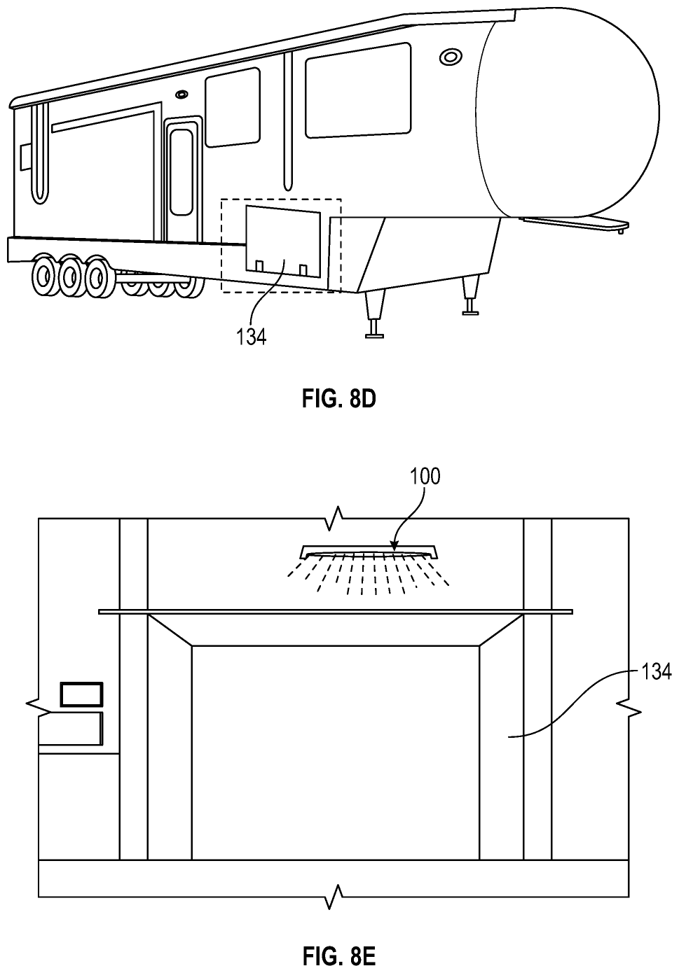

FIGS. 8A through 8E illustrate the application of the illumination device 100 of the present disclosure in various vehicle compartments. FIGS. 8A and 8B show a cross bed tool box 130 built in a vehicle with the illumination device 100 of the present disclosure. In FIG. 8A, the door of the tool box 130 is locked and closed, and in FIG. 8B, the door of the tool box 130 is unlocked and opened such that the light source of the illumination device 100 radiates light in the interior of the containment space. FIG. 8C shows vehicle compartments 132 built in a service truck. As shown in FIG. 8C, the illumination device 100 of the present disclosure is attached to the door of the vehicle compartments 132 and the light source radiates light in the interior of the containment space. FIG. 8D shows a Recreation Vehicle (RV) having a storage unit 134, and FIG. 8E shows the illumination device 100 is attached to the storage door and the light source of the illumination device 100 radiates light in the interior of the storage unit 134. As shown in FIGS. 8A-8E, the illumination device 100 is applied in various vehicles with the compartments and further the light source of the illumination device 100 casts the most efficient light and also radiates the light for wider compartment openings.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An illumination device for a storage unit having a locking system attached to a storage door and a containment space with an interior, the illumination device comprising:
a housing attached to the storage door, the housing including:
a link mechanism operatively connected to the locking system of the storage door, and
an actuator operatively connected to the link mechanism, the actuator operable to activate the locking system of the storage door between an unlocked state and a locked state; and
at least one light source electrically communicated with the actuator, the at least one light source radiating light towards the containment space,
wherein the actuator is activated to turn the at least one light source to an ON state when the link mechanism connected to the locking system is moved to the unlocked state from the locked state.

2. The illumination device of claim 1, wherein the actuator is activated to turn the at least one light source to an OFF state when the link mechanism connected to the locking system is moved to the locked state from the unlocked state.

3. The illumination device of claim 1, wherein the link mechanism includes a lock bolt operatively connected to a lock body of the locking system such that the link mechanism having the lock bolt is operable to activate the actuator to electrically communicate with the at least one light source.

4. The illumination device of claim 3, wherein the lock bolt is operatively coupled with a cylinder pin of the locking system such that the cylinder pin is moved in the lock bolt between the unlocked state of the locking system and the locked state of the locking system.

5. The illumination device of claim 4, wherein the lock bolt is formed with a stepped slot having a first location and a second location to receive the cylinder pin such that when the cylinder pin is positioned in the first location, the locking system is in the locked state and when the cylinder pin is positioned in the second location, the locking system is in the unlocked state.

6. The illumination device of claim 5, wherein in the unlocked state of the locking system, a user key stays in a key hole arranged in an outer side of the storage door.

7. The illumination device of claim 3, wherein the link mechanism further includes a nose piece connected to the actuator and scissor arms connected to the nose piece such that the link mechanism of the illumination device is configured to allow the actuator to electrically communicate with the at least one light source between the locked state and the unlocked state of the locking system.

8. The illumination device of claim 1, wherein the at least one light source is formed with a strip shape and attached to the housing along a longitudinal direction of the housing.

9. The illumination device of claim 1, wherein the at least one light source is formed with a V-shape and attached directly to an inner side of the storage door.

10. The illumination device of claim 1, wherein the at least one light source radiates light in a direction to the interior of the containment space.

11. The illumination device of claim 1, wherein the at least one light source is a light emitting diode (LED).

12. The illumination device of claim 1, wherein the illumination device is applied one or more of a cross bed storage unit, a service tuck compartment, a recreation vehicle (RV) compartment, and a tool box unit.

13. The illumination device of claim 4, wherein the lock bolt is formed with a cam type and the cam type lock bolt includes a slot having a first end and a second end to receive the cylinder pin such that the locking system is in the locked state when the cylinder pin is positioned in the first end and the locking system is in the unlocked state when the cylinder pin is positioned in the second end.

14. The illumination device of claim 3, wherein the link mechanism further includes a connecting bar connected between the actuator and the lock bolt such that the connecting bar of the illumination device is configured to allow the actuator to electrically communicate with the at least one light source between the unlocked state and the locked state of the locking system.

15. An illumination device for a storage unit having a locking system attached to a storage door and a containment space with an interior, the illumination device comprising:
a housing attached to the storage door, the housing including:
a link mechanism operatively connected to the locking system of the storage door, and
an actuator operatively connected to the link mechanism,
wherein the link mechanism includes a lock bolt operatively connected to a lock body of the locking system such that the link mechanism having the lock bolt is operable to activate the actuator to electrically communicate with a light source to radiate light towards the containment space; and
wherein the actuator is activated to turn the light source to an ON state when the link mechanism connected to the locking system is moved to the unlocked state from the locked state.

16. The illumination device of claim 15, wherein the actuator is activated to turn the light source to an OFF state when the link mechanism connected to the locking system is moved to the locked state from the unlocked state.

17. The illumination device of claim 15, wherein the light source is formed with a strip shape and attached to the housing along a longitudinal direction of the housing.

18. The illumination device of claim 15, wherein the light source is formed with a V-shape and attached directly to an inner side of the storage door.

19. An illumination device, comprising:
a housing attached to a storage door of a storage unit having a locking system and a containment space with an interior, the housing including:
a link mechanism operatively connected to the locking system of the storage door, and
an actuator operatively connected to the link mechanism, the actuator operable to activate the locking system of the storage door between an unlocked state and a locked state; and
a light source electrically communicated with the actuator, the light source radiating light towards the containment space,
wherein the actuator is activated to turn the light source to an ON state when the link mechanism connected to the locking system is moved to the unlocked state from the locked state.

20. The illumination device of claim 19, wherein the light source is formed with a strip shape and attached to the housing along a longitudinal direction of the housing or a V-shape and attached directly to an inner side of the storage door.
